(19) United States
(12) Patent Application Publication
(10) Pub. No.: US 2026/0285360 A1
(43) Pub. Date: Sep. 24, 2026

(54) System and method suitable for controlling a motion of a trailer-based vehicle in an environment

(71) Applicant: Mitsubishi Electric Research Laboratories, Inc., Cambridge, MA (US)

(72) Inventors: Yebin Wang, Boston, MA (US); Haitong Ma, Boston, MA (US); Tianpeng Zhang, Boston, MA (US); Na Li, US, MA (US); Stefano Di Cairano, Boston, MA (US)

(73) Assignee: Mitsubishi Electric Research Laboratories, Inc., Cambridge, MA (US)

(21) Appl. No.: 19/087,646

(22) Filed: Mar. 24, 2025

(51) Int. Cl. B60W 60/00; G05D 1/229; G06F 16/901

(52) U.S. Cl. CPC B60W 60/001; G05D 1/229; G06F 16/9024

(57) ABSTRACT

The present disclosure provides a system and a method for controlling a motion of a trailer-based vehicle. The method includes performing a graph-based search on a directed graph of connected nodes to generate a sequence of connected nodes linking an initial node representing an initial state with a target node representing a target state of the trailer-based vehicle. The method further includes executing, for each pair of connected nodes in the sequence of connected nodes, a neural network trained with reinforcement learning to produce a dynamically feasible motion trajectory. The method further includes generating a complete motion path for the trailer-based vehicle by concatenating the dynamically feasible motion trajectories associated with each pair of connected nodes in the sequence of connected nodes, and controlling the motion of the trailer-based vehicle along the complete motion path to reach the target state.

### TECHNICAL FIELD

The present disclosure relates generally to control systems, and more specifically to a system and a method suitable for controlling a motion of a trailer-based vehicle in an environment.

### BACKGROUND

Autonomous tractor-trailer systems have garnered significant attention from both industry and academia due to their potential to drastically improve cargo transportation efficiency, reduce human error, and increase safety on roads. Autonomous operation of these systems offers promising benefits, such as optimized fuel consumption, increased operational hours, and the ability to operate in hazardous or remote environments where human drivers may not be able to operate effectively. However, the complexity of dynamics involved in these tractor-trailer systems presents substantial challenges, especially when it comes to motion planning in dynamic and unpredictable environments. The challenges are even more pronounced when the tractor-trailer system is required to perform reversing maneuvers or navigate through constrained spaces while simultaneously avoiding collisions.

Furthermore, in practical applications, there is often a stringent limit on computation time and resources available for the motion planning. This tight budget for the computation time is especially critical in real-time systems, where delays in decision-making can lead to safety risks, inefficient operation, or even system failure. As a result, the challenges of the motion planning are compounded by a need to balance between computational efficiency and the complexity of a task of the tractor-trailer system.

The motion planning of the tractor-trailer system is essentially solving an optimal control problem (OCP), which aims to minimize a cost-to-go function while satisfying the tractor-trailer system's dynamic constraints, input limits, state boundaries, and collision-avoidance requirements. The OCP formulation ensures that the tractor-trailer system moves in a safe, efficient, and desired manner. However, the OCP is a complex constrained optimization problem solving which is far from trivial. Due to highly non-convex nature of the OCP, solutions lack feasibility guarantees, letting alone global convergence guarantees, making it difficult to ensure that a feasible solution (or an optimal solution) is found. This is particularly problematic in environments with numerous obstacles, narrow spaces, or highly dynamic traffic conditions, where the tractor-trailer system must continually adjust its motion planning strategies to avoid collisions.

Therefore, there is a need for an improved motion planning for the tractor-trailer system which can elegantly deal with challenges arising from the complexity of the dynamics as well as the environment.

### SUMMARY

It is an objective of some embodiments to provide a system and a method for motion planning for a trailer-based vehicle. The trailer-based vehicle includes a tractor and at least one trailer attached to the tractor such that a motion of the tractor controls a motion of the at least one trailer. Configurations of the trailer-based vehicle may vary based on their dimensions, and attachment between the tractor and the at least one trailer. The trailer-based vehicle may be an autonomous vehicle or a semi-autonomous vehicle.

It is also an objective of some embodiments to control a motion of the trailer-based vehicle from an initial state to a target state in the environment. The initial state includes at least an initial location and an initial heading of the trailer-based vehicle. The final state includes at least a final location and a final heading of the trailer-based vehicle. Additionally, it is an objective of some embodiments to control the motion of the trailer-based vehicle from the initial state to the target state while avoiding collision with obstacles in the environment.

Some embodiments are based on the recognition that such a control of the trailer-based vehicle can be achieved by solving a motion planning problem. The motion planning problem is characterized by high-complexity and real-time computation constraints, stemming from non-holonomic dynamics of the trailer-based vehicle and the practically meaningfulness, respectively. Precise maneuvering of the trailer-based vehicle with the nonholonomic dynamics, particularly in cluttered environments where long-horizon planning and collision avoidance, is critical for fully automated tractor-trailer systems. Solving the entire motion planning problem in a single optimization step is computationally intractable, especially given the real-time constraints of practical applications.

Some embodiments are based on the realization that dividing the motion planning problem into manageable components—one focused on global pathfinding and the other on local trajectory optimization—can reduce complexity without compromising feasibility. To this end, the motion planning problem is split into a graph-based search and reinforcement learning, as depicted in FIG. 1B. The graph-based search and the reinforcement learning, each possess significant, yet orthogonal, limitations, which correspond to different aspects of the problem. The graph-based search is efficient in representing global paths over long horizons but suffers from curse of dimensionality. This issue arises because a number of precomputed motion primitives required for feasible solutions grows exponentially with system complexity (characterized by the dimension of the system state), particularly when a trailer is added to the tractor. Thus, while the graph-based search excels at global abstraction, it struggles to provide a level of detail required for local trajectory optimization. For the graph-based search to deal with global abstraction as well as local system dynamic feasibility for high-dimensional systems, dimension reduction (of state space) has to be introduced to compute pre-motion primitives. Since the graph-based search will be carried out on a reduced state space, this treatment requires the initial and target states belong to the reduced state space—an unnecessary restriction.

Conversely, the reinforcement learning is well-suited for dynamically generating trajectories, making them effective for the localized local trajectory optimization-no need to impose restriction on the initial and target states. However, the reinforcement learning encounters scalability challenges when addressing numerous constraints, such as collision avoidance and kinematic feasibility. Further, the reinforcement learning approaches often fail to generalize in irregular or complex state spaces without structured guidance. While the reinforcement learning is efficient at the local trajectory optimization, it is less effective for achieving global consistency in the long-horizon planning.

Some embodiments are based on the realization that the graph-based search and the reinforcement learning are complementary and by combining high-level reference line graph search with low-level reinforcement learning based trajectory optimization, the two methods counterbalance each other's limitations while amplifying their strengths. Specifically, global weaknesses of the graph-based search—related to their inability to handle localized details (system dynamics and local environment)—are addressed through multiple local trajectory optimizations by the reinforcement learning. The local trajectory optimizations dynamically replace the motion primitives when connecting sub-goals or waypoints (well-defined over the reduced order state space), thereby avoiding the high-dimensionality problems inherent in the graph-based search and reducing computation time.

In practice, the graph-based search provides a structured, global framework by defining reference lines and waypoints that simplify the dimensional complexity of the motion control problem. The reinforcement learning, in turn, focuses on connecting these waypoints with precise, dynamically feasible, and collision-free trajectories. By operating within the reference lines and waypoints defined by the graph-based search, the reinforcement learning avoids a need to explore the environment, thereby achieving both scalability and efficiency.

Such a motion planning framework based on the graph-based search and the reinforcement learning delivers substantial technical improvements, including reduced computation time, improved scalability, and higher planning success rates compared to traditional methods. By recognizing complementary strengths of the graph-based search and the reinforcement learning, the embodiments establish a robust system for motion planning of the trailer-based vehicle, with potential adaptability for other high-dimensional, constrained systems.

Accordingly, one embodiment discloses a system for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer. The system comprises a processor; and a memory having instructions stored thereon that, when executed by the processor, cause the system to: perform a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair; execute, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility; generate a complete motion path for the trailer-based vehicle by concatenating the dynamically feasible motion trajectories associated with each pair of connected nodes in the sequence of connected nodes, wherein the complete motion path connects the initial state and the target state; and control the motion of the trailer-based vehicle along the complete motion path to reach the target state in the environment.

Accordingly, another embodiment discloses a method for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer. The method comprises performing a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair; executing, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility; generating a complete motion path for the trailer-based vehicle by concatenating the dynamically feasible motion trajectories associated with each pair of connected nodes in the sequence of connected nodes, wherein the complete motion path connects the initial state and the target state; and controlling the motion of the trailer-based vehicle along the complete motion path to reach the target state in the environment.

Accordingly, yet another embodiment discloses a non-transitory computer-readable storage medium embodied thereon a program executable by a processor for performing a method for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer. The method comprises performing a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair; executing, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility; generating a complete motion path for the trailer-based vehicle by concatenating the dynamically feasible motion trajectories associated with each pair of connected nodes in the sequence of connected nodes, wherein the complete motion path connects the initial state and the target state; and controlling the motion of the trailer-based vehicle along the complete motion path to reach the target state in the environment.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates an environment in which a trailer-based vehicle is operating, according to some example embodiments of the present disclosure.

FIG. 1B illustrates a motion planning problem split into a graph-based search and reinforcement learning, according to some example embodiments of the present disclosure.

FIG. 1C shows a block diagram of a system for controlling a motion of the trailer-based vehicle from an initial state to a target state in the environment, according to an embodiment of the present disclosure.

FIG. 1D illustrates a block diagram of functions executed by the system for controlling the trailer-based vehicle, according to an embodiment of the present disclosure.

FIG. 1E illustrates a directed graph of connected nodes corresponding to the environment, according to some embodiments of the present disclosure.

FIG. 2 illustrates a block diagram for generating a complete motion path, according to an embodiment of the present disclosure.

FIG. 3 illustrates dynamics of the trailer-based vehicle, according to an embodiment of the present disclosure.

FIG. 4 illustrates a block diagram of a method for estimating a shortest kinematically feasible path between nodes of the directed graph of connected nodes, according to an embodiment of the present disclosure.

FIG. 5 illustrates an example of i^{th} local trajectory optimization, according to an embodiment of the present disclosure.

FIG. 6A illustrates a parking space, according to an embodiment of the present disclosure.

FIG. 6B illustrates reference lines constructed by the system, according to an embodiment of the present disclosure.

FIG. 6C illustrates sub-goals outputted by the graph-based search, according to an embodiment of the present disclosure.

FIG. 6D illustrates a trajectory of the trailer-based vehicle for reaching a target parking spot, according to an embodiment of the present disclosure.

FIG. 6D illustrates a trajectory of the trailer-based vehicle for making U-turn and reaching a target state, according to an embodiment of the present disclosure.

FIG. 7 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

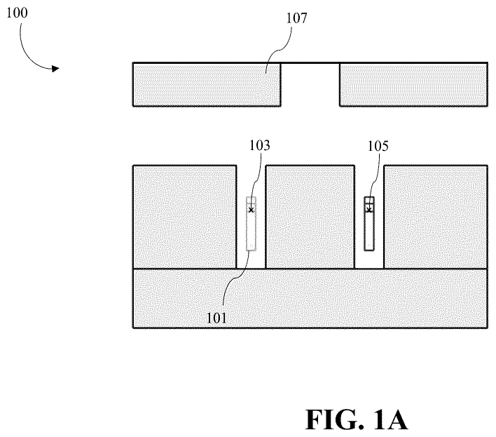

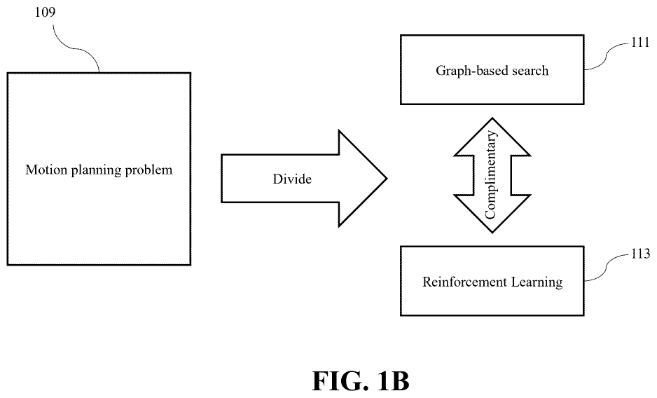

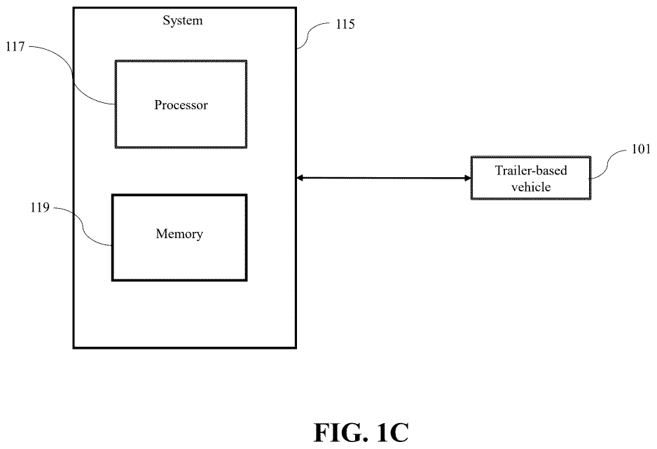

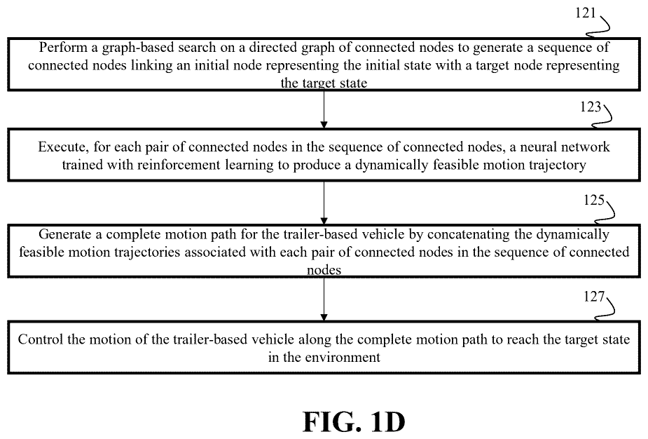

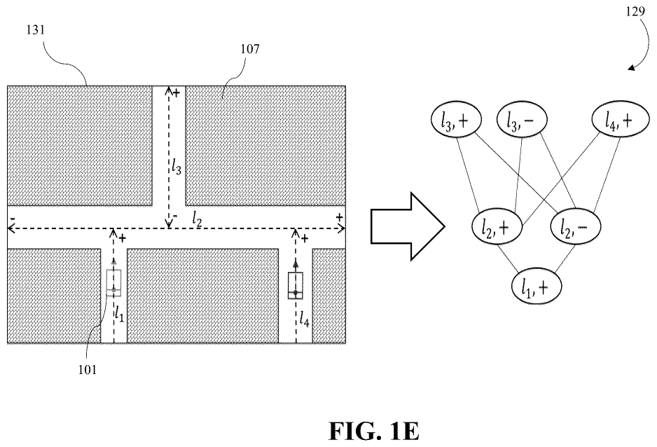

FIG. 1A illustrates an environment 100 in which a trailer-based vehicle 101 is operating, according to some example embodiments of the present disclosure. The trailer-based vehicle 101 includes a tractor and at least one trailer attached to the tractor such that a motion of the tractor controls a motion of the at least one trailer. Configurations of the trailer-based vehicle 101 may vary based on their dimensions, carrying capacities, and attachment between the tractor and the at least one trailer. The trailer-based vehicle 101 may be an autonomous vehicle or a semi-autonomous vehicle.

It is an objective of some embodiments to control a motion of the trailer-based vehicle 101 from an initial state 103 to a target state 105 in the environment 100. The initial state 103 includes at least an initial location and an initial heading of the trailer-based vehicle 101. The final state 105 includes at least a final location and a final heading of the trailer-based vehicle 101. Additionally, it is an objective of some embodiments to control the motion of the trailer-based vehicle 101 from the initial state 103 to the target state 105 while avoiding collision with obstacles 107 in the environment 100.

Some embodiments are based on the recognition that such a control of the trailer-based vehicle 101 can be achieved by solving a motion planning problem 109, as shown in FIG. 1B. The motion planning problem 109 is characterized by high-dimensionality of system dynamics, collision avoidance constraints, and real-time computation constraints, stemming from non-holonomic dynamics of the trailer-based vehicle 101 and the environment 100. Precise maneuvering of the trailer-based vehicle with the nonholonomic dynamics, particularly in cluttered environments where long-horizon planning and collision avoidance, is critical for fully automated tractor-trailer systems. Solving the entire motion planning problem 109 in a single optimization step is computationally intractable, especially given the real-time constraints of practical applications.

Some embodiments are based on the realization that dividing the motion planning problem 109 into manageable components—one focused on global pathfinding and the other on local trajectory optimization—can reduce complexity without compromising feasibility. To this end, the motion planning problem 109 is split into a graph-based search 111 and reinforcement learning 113, as depicted in FIG. 1B. The graph-based search 111 and the reinforcement learning 113, each possess significant, yet orthogonal, limitations, which correspond to different aspects of the problem. The graph-based search 111 is efficient in representing global paths over long horizons but suffers from curse of dimensionality. This issue arises because a number of precomputed motion primitives required for feasible solutions grows exponentially with system complexity (the dimension of system state), particularly when a trailer is added to the tractor. Thus, while the graph-based search 111 excels at global abstraction, it struggles to provide a level of detail required for local trajectory optimization.

Conversely, the reinforcement learning 113 are well-suited for dynamically generating trajectories, making them effective for the local trajectory optimization. However, the reinforcement learning 113 encounters scalability challenges when addressing numerous constraints, such as collision avoidance and kinematic feasibility. Further, the reinforcement learning 113 approaches often fail to generalize in irregular or complex state spaces without structured guidance. While the reinforcement learning 113 is efficient at the local trajectory optimization, it is less effective for achieving global consistency in the long-horizon planning.

Some embodiments are based on the realization that the graph-based search 111 and the reinforcement learning 113 are complementary and by combining high-level reference line graph search with low-level reinforcement learning based trajectory optimization, the two methods counterbalance each other's limitations while amplifying their strengths. Specifically, global weaknesses of the graph-based search 111—related to their inability to handle localized details—are addressed through multiple local trajectory optimizations by the reinforcement learning 113. The local trajectory optimizations dynamically replace the motion primitives when connecting sub-goals or waypoints, thereby avoiding the high-dimensionality problems inherent in the graph-based search 111 and reducing computation time.

In practice, the graph-based search 111 provides a structured, global framework by defining reference lines and waypoints that simplify the dimensional complexity of the motion control problem 109. The reinforcement learning 113, in turn, focuses on connecting these waypoints with precise, dynamically feasible, and collision-free trajectories. By operating within the reference lines and waypoints defined by the graph-based search 111, the reinforcement learning 113 avoids a need to explore the environment 100, thereby achieving both scalability and efficiency.

Such a motion planning framework based on the graph-based search 111 and the reinforcement learning 113 delivers substantial technical improvements, including reduced computation time, improved scalability, and higher planning success rates compared to traditional methods. By recognizing complementary strengths of the graph-based search 111 and the reinforcement learning 113, the embodiments establish a robust system for motion planning of the trailer-based vehicle 101, with potential adaptability for other high-dimensional, constrained systems. Based on such a motion planning framework, some embodiments provide a system for controlling the motion of the trailer-based vehicle 101 from the initial state 103 to the target state 105 in the environment 100.

FIG. 1C shows a block diagram of a system 115 for controlling the motion of the trailer-based vehicle 101 from the initial state 103 to the target state 105 in the environment 100, according to an embodiment of the present disclosure. The system 115 is communicatively coupled to the trailer-based vehicle 101. In some embodiments, the system 115 is integrated into the trailer-based vehicle 101. In accordance with an embodiment, the trailer-based vehicle 101 may include an inertial measurement unit (IMU) that may include 3-axis accelerometer(s), 3-axis gyroscope(s), and/or magnetometer(s). The IMU is used to sense the operation of the trailer-based vehicle 101. Further, the trailer-based vehicle 101 may include a global positioning system sensor for providing position, headings, and velocity of the trailer-based vehicle 101 to the system 115.

The system 115 includes a processor 117 and a memory 119. The processor 117 may be a single core processor, a multi-core processor, a computing cluster, or any number of other configurations. The memory 119 may include random access memory (RAM), read only memory (ROM), flash memory, or any other suitable memory systems. Additionally, in some embodiments, the memory 119 may be implemented using a hard drive, an optical drive, a thumb drive, an array of drives, or any combinations thereof. The memory 119 having instructions stored thereon that, when executed by the processor 117, cause the system 115 to execute functions for controlling the trailer-based vehicle 101.

FIG. 1D illustrates a block diagram of the functions executed by the system 115 for controlling the trailer-based vehicle 101, according to an embodiment of the present disclosure. At block 121, the processor 117 is configured to perform the graph-based search 111 on a directed graph of connected nodes to generate a sequence of connected nodes linking an initial node representing the initial state 103 with a target node representing the target state 105. According to some embodiments, the initial node representing the initial state is a closest node on the directed graph to the initial state, and wherein the target node representing the target state is a closest node on the directed graph to the target state.

Each node on the directed graph defines a state of the trailer-based vehicle 101, and each edge connecting a pair of nodes defines a kinematically feasible motion of the trailer-based vehicle in a direction from a first node of the pair to a second node of the pair. In some embodiments, the memory 119 is configured to store the directed graph of connected nodes.

In some embodiments, the node on the directed graph has a lower dimension than the state of the trailer-based vehicle 101. For example, the velocity and steering angle of the tractor are a portion of the state of the trailer-based vehicle 101, but might not present in the node.

FIG. 1E illustrates a directed graph 129 of connected nodes corresponding to the environment 100, according to some embodiments of the present disclosure. The directed graph 129 of connected nodes is constructed using reference lines that represent the environment 100, and each node corresponds to a directed segment of a reference line with predefined orientations.

Given a roadmap 131 of the environment 100, the reference lines are directed line segments l₁, l₂, . . . , lₙ that constitute a skeleton of the roadmap 131. Each lᵢ is endowed with two cardinal directions + and − denoted as nodeᵢ=(lᵢ, σᵢ) where σ∈(+, −). The directed graph 129 is defined by transition feasibility between reference line segments. Each node is a directed reference line segment (lᵢ, σᵢ) and an edge exists between two nodes (lᵢ, σᵢ) and (lⱼ, σⱼ) if there are states sᵢ∈(lᵢ, σᵢ) and sⱼ∈(lⱼ, σⱼ), such that sᵢ can transition to sⱼ with a simple motion (forward, backward, left turn, right turn) while likely avoiding the obstacles 107. For instance, there is an edge between (l₁, +) and (l₂, +) because the tractor can transition between the two with a 90-degree turn; meanwhile, since it is impossible to transition from (l₁, +) to (l₃, +) without chaining more than one simple motion together, there is not a direct edge between them. In some embodiments, an edge is assigned a cost which measures the best path to achieve the transition between two nodes. The best path is represented by the minimum length Reeds-Shepp path between the two nodes.

Referring back FIG. 1D, at block 121, the processor 117 is configured to perform the graph-based search 111 on the directed graph 129 of connected nodes to generate the sequence of connected nodes linking the initial node representing the initial state 103 with the target node representing the target state 105. In some embodiments, the processor 117 is further configured to dynamically adjust the graph-based search 111 to account for changes in the environment 100, including updates to obstacle positions or traffic conditions.

At block 123, the processor 117 is configured to execute, for each pair of connected nodes in the sequence of connected nodes, a neural network trained with the reinforcement learning 113 to produce a dynamically feasible motion trajectory. In an embodiment, the neural network trained with the reinforcement learning 113 is stored in the memory 119 of the system 115. In another embodiment, the neural network trained with the reinforcement learning 113 is stored in an external storage and the system 115 obtains the neural network from the external storage during controlling of the trailer-based vehicle 101. The neural network is trained offline, i.e., in advance. Additionally or alternatively, the neural network is trained online, i.e., in real-time.

The dynamically feasible motion trajectory satisfies vehicle dynamics constraints, including a collision avoidance constraint and a kinematic feasibility constraint. The collision avoidance constraint ensures that the trailer-based vehicle 101 avoids obstacles 107 or other vehicles in its environment 100, preventing potential collisions. The kinematic feasibility constraint ensures that the dynamically feasible motion trajectory is physically achievable based on the trailer-based vehicle's 101 capabilities (e.g., speed, steering limits, turning radius). In other words, the kinematic feasibility constraint ensures that the trajectory is compatible with the trailer-based vehicle's 101 motion dynamics and that the trailer-based vehicle 101 can follow it smoothly.

At block 125, the processor 117 is configured to generate a complete motion path for the trailer-based vehicle 101 by concatenating the dynamically feasible motion trajectories associated with each pair of connected nodes in the sequence of connected nodes. The generated complete motion path connects the initial state 103 and the target state 105.

At block 127, the processor 117 is configured to control the motion of the trailer-based vehicle 101 along the generated complete motion path to reach the target state 105 in the environment. In a particular, based on the complete motion path, the processor 117 is configured to generate control inputs to one or more actuators of the trailer-based vehicle 101. The control inputs include values of an acceleration and/or a steering rate of the trailer-based vehicle 101. The control inputs are applied to the one or more actuators, causing the trailer-based vehicle 101 to track the complete motion path to reach the target state 105.

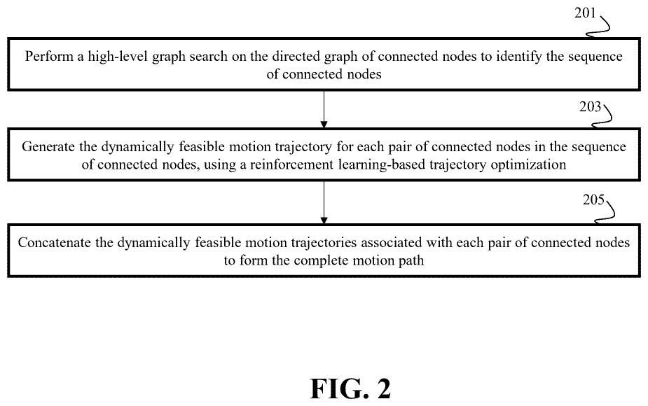

FIG. 2 illustrates a block diagram for generating the complete motion path, according to an embodiment of the present disclosure. At block 201, the processor 117 is configured to perform a high-level graph search on the directed graph of connected nodes to identify the sequence of connected nodes. Further, at 203, the processor 117 is configured to generate the dynamically feasible motion trajectory for each pair of connected nodes in the sequence of connected nodes, using a reinforcement learning-based trajectory optimization to ensure dynamically feasible transitions between states of the trailer-based vehicle. At block 205, the processor 117 is configured to concatenate the dynamically feasible motion trajectories associated with each pair of connected nodes to form the complete motion path.

Further, the graph-based search 111 and the reinforcement learning 113 are mathematically described below.

### Tractor-Trailer System

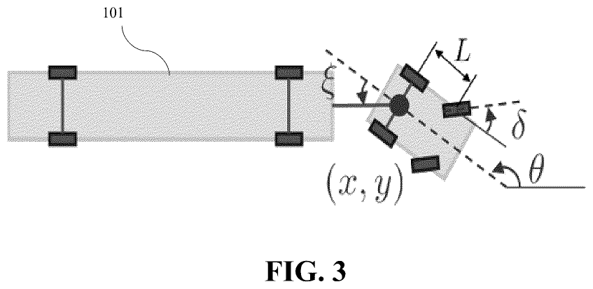

FIG. 3 illustrates dynamics of the trailer-based vehicle 101, according to an embodiment of the present disclosure. (x, y)^{T} are coordinates of a midpoint of the tractor's rear wheel axis, θ is the tractor orientation/heading, θ₁ is orientations of trailer, v_{f} is a front-wheel velocity of the tractor, δ is a steering angle of the tractor, and L is a wheelbase on the tractor. A mechanical constraint |δ|≤δₘₐₓ limits the minimum turning radius R of a path with

$$tan ( {δ}_{max} ) = \frac{L}{R} .$$

Tractor-trailer dynamics model \dot{s}=f(s, u) is given in coordinates s=(x, y, θ, ξ, v, δ)^{T} as follows:

$$\dot{x} = cos ( θ ) v \dot{ξ} = - \frac{v sin ( ξ )}{{d}_{1}} - \frac{v tan ( δ )}{L} \qquad ( 1 )$$

$$\dot{y} = sin ( θ ) v \dot{v} = {u}_{1}$$

$$\dot{θ} = \frac{v tan ( δ )}{L} \dot{δ} = {u}_{2}$$

where the control inputs are the acceleration u₁ and the steering rate u₂. The trailer-based vehicle 101 needs to avoid a jackknife configuration. Therefore, a jackknife prevention constraint is enforced. The jackknife prevention constraint that prevents the jackknife configuration is given as

$$\vert ξ \vert \leq {ξ}_{max} , \qquad ( 2 )$$

$$where {ξ}_{max} must be less than \frac{π}{2} .$$

The jackknife configuration refers to a situation where the trailer swings sideways and forms an angle with the tractor, resembling a shape of a “jackknife” (a folding knife). This typically happens when the tractor and the trailer are not properly aligned or when the trailer begins to turn too sharply, especially during sudden braking, poor road conditions, or when there's a loss of traction.

### Motion Planning Problem Formulation

Denote [symbol] the collision-free configuration space of system (1). Given an initial configuration sᵢ∈ [symbol] (initial state 103) and a goal configuration s_{f}∈ [symbol] (target state 105), the system 115 to find a feasible trajectory which starts at sᵢ and ends at s_{f}, while satisfying (1) and a series of constraints,

$${min}_{{u}_{0} , {u}_{1} , … , {n}_{{N}_{1}} , N} {\sum }_{t = 1}^{N} l ( {s}_{t} , {u}_{t} ) \qquad ( 3 )$$

$$s . t . {s}_{0} = {s}_{i} , {s}_{N} = {s}_{f} \qquad ( 4 )$$

$${s}_{t} = {f}_{d} ( {s}_{t - 1} , {u}_{t - 1} ) , {s}_{t} ∈ {𝒮}_{free} \qquad ( 5 )$$

$$\vert {v}_{t} \vert \leq {v}_{max} , \vert {δ}_{t} \vert \leq {δ}_{max} , \vert {ξ}_{t} \vert \leq \frac{π}{2} \qquad ( 6 )$$

$${a}_{min} \leq {a}_{t} \leq {a}_{max} , {\dot{δ}}_{min} \leq {ψ}_{t} \leq {\dot{δ}}_{max} \qquad ( 7 )$$

$$∀ t = 1 , 2 , … , N$$

where l is a cost function, f_{d} in (5) is a proper discretization of continuous tractor-trailer dynamics in (1), (6) indicates an operation range of velocity v, steering angle δ, and avoidance of the jack-knife configuration on a relative angle ξ, and (7) indicates input constraints.

Directly solving (3)-(7) with the reinforcement learning (RL) is very difficult empirically for multiple reasons. For instance, the dynamics is non-holonomic, which results in that the tractor-trailer usually needs complex maneuvers to reach goal state. Simply defining reward as minimizing Euclidean distance will not guide to correct solutions. Further, time step N is not fixed while there exists terminal constraints on a terminal time step. Finally, the problem includes collision-free constraints.

To handle these challenges, some embodiments provide a hierarchical framework, where a high-level graph search decides a set of intermediate waypoints as guidance, and a low-level RL-based trajectory generator solves sub-tasks connecting successive waypoints, as described below.

### Graph-Based Search

Some embodiments leverage A*-based graph search, which uses a heuristic cost function to guide a shortest path search. A cost to reach the target state is estimated as a sum of a heuristic cost to reach the target state and an actual cost from the initial state 103 to the target node 105. Then the A* algorithm maintains an open set of nodes to explore, prioritizing nodes with lowest total estimated cost until the target node is explored.

In some embodiments, the graph-based search 111 uses the heuristic cost function based on Reeds-Shepp cost to estimate a shortest kinematically feasible path between nodes qⱼ and qₖ of the directed graph of connected nodes. According to an embodiment, the Reeds-Shepp cost between qⱼ and qₖ means minimal distances to turn a Reeds-Shepp car from the node qⱼ to the node qₖ, where Reeds-Shepp car is a car that can move in both forward and reverse directions.

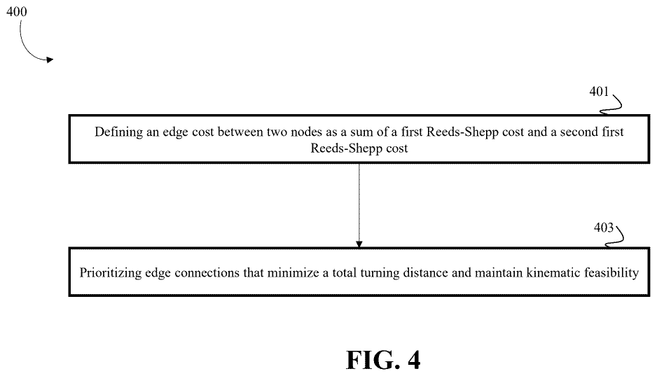

FIG. 4 illustrates a block diagram of a method for estimating the shortest kinematically feasible path between the nodes qⱼ and qₖ of the directed graph of connected nodes, according to an embodiment of the present disclosure. At block 401, the method 400 includes defining an edge cost between two nodes as a sum of a first Reeds-Shepp cost and a second first Reeds-Shepp cost.

The first Reeds-Shepp cost represents a minimal turning distance for aligning the trailer-based vehicle 101 with a reference line associated with the first node, and the second Reeds-Shepp cost represents a minimal turning distance from an aligned state to a reference line associated with the second node. The aligned state refers to the trailer-based vehicle 101 aligned with the reference line associated with the first node. The trailer-based vehicle 101 aligning with the reference line means the position of the trailer-based vehicle 101 is on the reference line and a heading angle of the trailer-based vehicle 101 is the same as the reference line direction. The first and second Reeds-Shepp cost are considered on 2D space, thereby computation burden is reduced.

At block 403, the method 400 includes prioritizing edge connections that minimize a total turning distance and maintain kinematic feasibility.

In some embodiments, the cost to reach the target state is defined as the sum of two Reeds-Shepp costs, which is solved the following optimization problem,

$$EdgeCost ( {node}_{i} , {node}_{j} ) = {min}_{{{s}^{*} ∈ ( {l}_{i} , {σ}_{i} )}_{{s}^{j} ∈ ( {l}_{j} , {σ}_{j} )}} {c}_{RS} ( {s}^{i} , {s}^{*} ) + {c}_{RS} ( {s}^{*} , {s}^{j} ) \qquad ( 8 )$$

where notation nodeᵢ=(lᵢ, σᵢ), and s*∈(lᵢ, σᵢ) mean the tractor align with the reference line (lᵢ, σᵢ) . . . c_{RS}(s, s′) is the Reeds-Shepp cost transition from the tractor state in s to tractor state in s′. Note that the Reeds-Shepp cost of the tractor is considered for simplicity. s_{*} is an intermediate waypoint.

Additionally, for the heuristic cost function, some embodiments use the Reeds-Shepp cost,

$$Heurstic ( {node}_{i} , {node}_{goal} ) = {c}_{R S} ( {s}^{i} , {s}_{f} ) \qquad ( 9 )$$

where sᵢ is already solved in (8) since the heuristic can be calculated after the actual cost is calculated.

The processor 117 is configured to search the shortest kinematically feasible path using A* with cost (8) and heuristic (9). Further, the processor 117 is configured to recover sub-goals on the shortest kinematically feasible path using solutions of (8).

### Reinforcement Learning-Based Trajectory Optimization

In some embodiments, the processor 117 is configured to solve the local trajectory optimization using a primal-dual RL algorithm, which connects successive sub-goals generated by the graph-based search.

### RL Problem Formulation

The graph-based search 111 outputs a high-level path {s⁰, s¹, s², . . . , s^{K}} with s⁰=sᵢ, s^{K}=s_{f}, and the goal of the local trajectory optimization is to approximately connect successive waypoint pairs (s⁰, s¹), (s¹, s²), . . . , (s^{K-1}, s^{K}) with a dynamic feasible and collision-free trajectory.

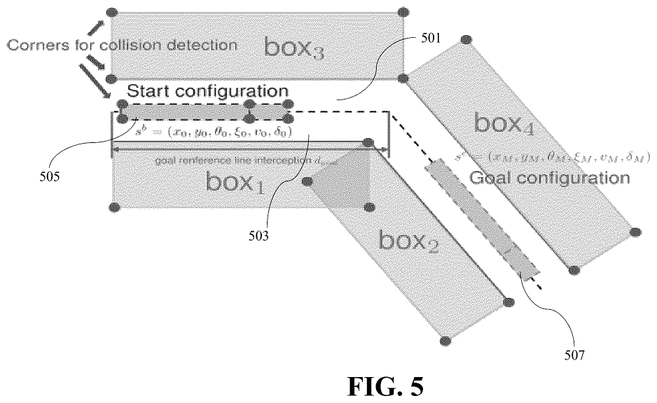

FIG. 5 illustrates an example of i^{th} local trajectory optimization, according to an embodiment of the present disclosure. A goal of the local trajectory optimization is connecting (sⁱ⁻¹, sⁱ) within finite time steps while avoiding obstacles. Free space of i^{th} is modeled as two safety corridors 501 and 503 centered around a start reference line and a goal reference line, denoted by

$${𝒮}_{free}^{i} . ( {s}^{b} , {s}^{e} )$$

to denote a beginning sub-goal configuration 505 and an ending sub-goal configuration 509, differentiating them from the initial state 103 and the target state 105.

In this following paragraphs, initial state 103 is used interchangeably with beginning sub-goal configuration 505; and target state 105 is used interchangeably with ending sub-goal configuration 509, without confusion from the context. Some embodiments consider Markovian Decision Process (MDP) [symbol] = [symbol] [symbol] , [symbol] , r, h, P, M, ρ^{b}, ρ^{e} [symbol] . State space includes tractor-trailer states sₜ and free space information. Inputs to the tractor-trailer are acceleration \dot{v} and steering rate \dot{δ} in (1). Reward function r: [symbol] × [symbol] → [symbol] and collision function h: [symbol] × [symbol] → [symbol] design will be presented in the following section, where d is a constraint dimension. Transition dynamics P follows vehicle transition dynamics (1), and M is the maximum number of time steps to reach the target state 105. ρ^{b}, ρ^{e} are the initial state and the target state distribution. Given an observation function o that maps state s∈ [symbol] to observation space o∈ [symbol] (construction explained later) and policy π: [symbol] →Δ( [symbol] ) to optimize, an optimization problem for RL is

$${min}_{π} J ( π ) := {𝔼}_{{{s}_{o} \sim {ρ}^{b}}_{{{s}_{t} \sim P ( \cdot \vert {s}_{t} , {u}_{t} )}_{{u}_{t} \sim π ( \cdot \vert o ( {s}_{t} ) )}}} [ {\sum }_{t = 1}^{M} r ( {s}_{t} , {u}_{t} ) ] \qquad ( 10 )$$

$$s . t . {s}_{M} = {s}^{e} ∼ {ρ}^{e} \qquad ( 11 )$$

$${s}_{t} ∈ {𝒮}_{f r e e}^{i} , \vert {ξ}_{t} \vert \leq \frac{π}{2} , ∀ t = 1 , … , M \qquad ( 12 )$$

where dynamics feasibility and input constraints are implicitly embedded in the dynamics P and the policy π.

Further, in some embodiments, the RL incorporates reachability-based safety constraints to ensure collision-free trajectories between nodes of the directed graph 129 of connected nodes. The reachability-based safety constraints are implemented by defining the safety corridors 501, 503 along a trajectory connecting successive nodes. The safety corridors are constructed based on relative positions and orientations of the trailer-based vehicle 101 and nearby obstacles (e.g., obstacles 109) to ensure that the trailer-based vehicle 101 remains within collision-free regions throughout its motion while incorporating constraints on a relative angle between the tractor and the trailer to prevent the jackknife configurations during both forward and reverse motions of the trailer-based vehicle 101.

### Training Setup

To learn a general RL controller that works for multiple sub-tasks (i.e., local trajectory optimization), many local maps are generated. In an embodiment, the RL uses a batch trajectory sampling technique to generate and evaluate multiple candidate trajectories for training. For example, at first, reference line interception l_{goal}, and relative angle of start and end reference line are randomly sampled, then the beginning sub-goal configuration (s^{b}) and the ending sub-goal configuration (s^{e}) aligning with the two reference lines are randomly sampled. Further, safety corridor widths of the start and goal reference lines are sampled within a reasonable range.

Observation space. The observations space includes

$$\{ {s}^{b} , {s}_{t} , {s}^{e} \} ⋃ \{ {p}_{i}^{j} \vert j ∈ \{ ll , ul , ur , lr \} ,$$

i∈{tractor, tailer, box₁, box₂, box₃, box₄}}, where s^{b} is the beginning sub-goal configuration, sₜ is the current state, s^{e} is the ending sub-goal configuration, and others are the free space information.

$${p}_{i}^{j}$$

is four corner points (“ll” for lower left corner, “ul” for upper left corner, etc.) of the tractor, trailer, and four obstacles represented as collision boxes—‘box1’, ‘box2’, ‘box3’, and ‘box4’, in the FIG. 5.

The present disclosure further discloses an embodiment of reward and constraints design. Reward function is given by

$$r ( {s}_{t} , {u}_{t} ) = - 1 ( ‖ {s}_{M} - {s}^{e} ‖ \leq ϵ ) + 0.01 {‖ u ‖}^{2} \qquad ( 13 )$$

where ϵ is an admissible error and 1(∥s_{M}−s^{e}∥≤ϵ)=1 if ∥s_{M}−s^{e}∥≤ϵ; 1(∥s_{M}−s^{e}∥≤ϵ)=0, otherwise. For constraint design, every time step has safety constraints in (11) and (12). These constraints are reformulated to trajectory-based reachability constraints as following,

$${max}_{t ∈ \{ 1 , 2 , … , M \}} - d ( {s}_{t} ) \leq 0 , {max}_{t ∈ \{ 1 , 2 , … , M \}} \vert {ξ}_{t} \vert \leq \frac{π}{2} \qquad ( 14 )$$

where d(s): [symbol] → [symbol] as a signed distance to all the collision boxes and d(s)≥0 indicates the tractor and trailer are not colliding with the collision boxes. Calculation of the signed distance is based on separating axis theorem since both the vehicles and obstacles are convex. Combining these constraints, (5) is reformulated to an optimization algorithm,

$${min}_{π} {𝔼}_{{s}_{o} ∼ {p}^{b} {s}_{t} ∼ P ( \cdot \vert {s}_{t} , {u}_{t} ) {u}_{t} ∼ π ( \cdot \vert o ( {s}_{t} ) )} [ {\sum }_{t = 1}^{M} r ( {s}_{t} , {u}_{t} ) ] \qquad ( 15 )$$

$$s . t . ‖ {s}_{M} - {s}^{e} ‖ \leq ϵ ∀ {s}^{e} ∼ {ρ}^{e}$$

$${max}_{t ∈ \{ 1 , 2 , … , M \}} - d ( {s}_{t} ) \leq 0 , {max}_{t ∈ \{ 1 , 2 , … , M \}} \vert {ξ}_{t} \vert \leq \frac{π}{2} , ∀ {s}_{0} ∼ {ρ}^{b}$$

### Algorithm Design

Some embodiments are based on the recognition that the primal-dual RL algorithm can be used to solve constrained policy optimization (15). However, one issue is that every initial state has constraints, so dual variables or multipliers are assigned for every initial state. State-wise multiplier mapping is denoted as λ:

$$𝒮 \to {ℝ}_{+}^{d} .$$

The primal-dual optimization problem becomes

$${max}_{λ} {min}_{π} L ( π , λ ) := {𝔼}_{{s}_{o} ∼ ρ {s}_{t} ∼ P ( \cdot \vert {s}_{t} , {u}_{t} ) {u}_{t} ∼ π ( \cdot \vert o ( {s}_{t} ) )} [ {\sum }_{t = 1}^{M} r ( {s}_{t} , {u}_{t} ) ] + {\int }_{{s}_{o}} {λ}^{T} ( {s}_{0} ) {h}^{π} ( {s}_{0} ) d {s}_{0} \qquad ( 16 )$$

where L(π, λ) is Lagrangian and

$${h}^{π} ( {s}_{0} ) = {[ ‖ {s}_{M} - {s}^{e} ‖ - ϵ , {max}_{t ∈ \{ 1 , 2 , … , M \}} - d ( {s}_{t} ) , {max}_{t ∈ \{ 1 , 2 , … , M \}} \vert {ξ}_{t} \vert - \frac{π}{2} ]}^{⊤}$$

are the constraints. In practical algorithm, neural networks are to parametrize policy π_{ζ} and dual variable λ_{η} with parameters ζ and η. Uniform initial state distribution is used in a bounded support and integral term in (16) is approximated by sample mean [symbol] λ(s₀)^{T}h^{π}(s₀). This will cause λ to scale up by a constant factor 1/ρ(s), which does not affect an optimal policy.

Model-based policy gradient—As differentiable dynamics model f, reward function r, and every element in constraints h^{π} are known, a model-based policy gradient

$$\frac{\partial L ( π , λ )}{\partial π}$$

can be directly calculated. Compared to model-free policy gradient, the model-based policy gradient is accurate and the training will be more stable.

Stochastic policy—Some embodiments are based on the recognition that accurate control is required to reach the ending sub-goal configuration (s^{e}) but the RL has been shown to not be precise enough empirically. A stochastic policy can be used to very efficiently generate many trajectory candidates to obtain a trajectory which precisely reaches the ending sub-goal configuration (s^{e}). To this end, the reinforcement learning includes the stochastic policy that samples trajectories from a Gaussian distribution generate multiple trajectory candidates between two nodes and select the best one to enhance trajectory precision and target state accuracy. In an embodiment, Gaussian random policy uₜ~ [symbol] (π_{d}(oₜ), σ²I₂) is used, where π_{d} is a deterministic mapping that maps from observations to a mean value and σ² is a constant variance. Then after training, the stochastic policy is used to sample a batch of trajectories and select the one with its end state closest to the ending sub-goal configuration (s^{e}) without causing collision.

Some embodiments in the present disclosure employ supervised learning initialization from state-lattice-based methods to warm start the RL training and thus improve training performance and reduce training time. Initialization is key to the performance of the neural network trained with the RL. Therefore, state-lattice-based methods, e.g. A-search guided tree is used to generate feasible trajectories (by solving open-loop optimal control problems offline) and initialize a policy mean value with supervised learning. Therefore, the processor 117 is configured to initialize the neural network trained with the RL using the trajectories generated by the solving open-loop optimal control problems, in the manner as in the state-lattice-based methods.

The neural network trained with the RL implements a mapping between its input and output. The input includes one or more of the current state of the trailer-based vehicle 101, the target state 105, maximum relative angle between the tractor and the trailer and maximum steering angle of the trailer-based vehicle 101, vertices of the obstacles, and length and width of an open space in the safety corridors. The output includes the control inputs of the trailer-based vehicle 101.

The system 115 can be used to control the motion of the trailer-based vehicle 101 to park the trailer-based vehicle 101 at a target parking space in a parking space environment.

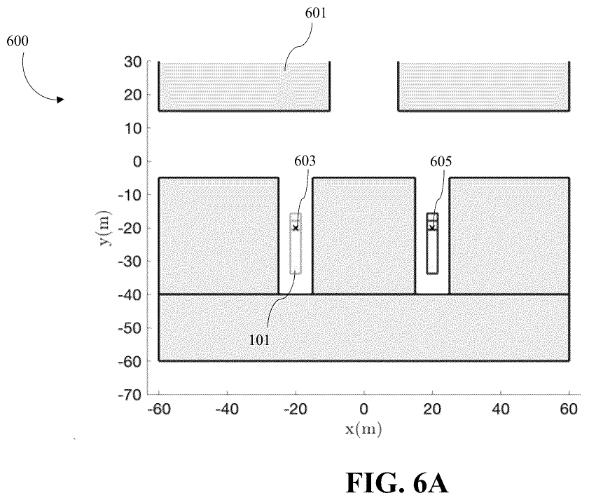

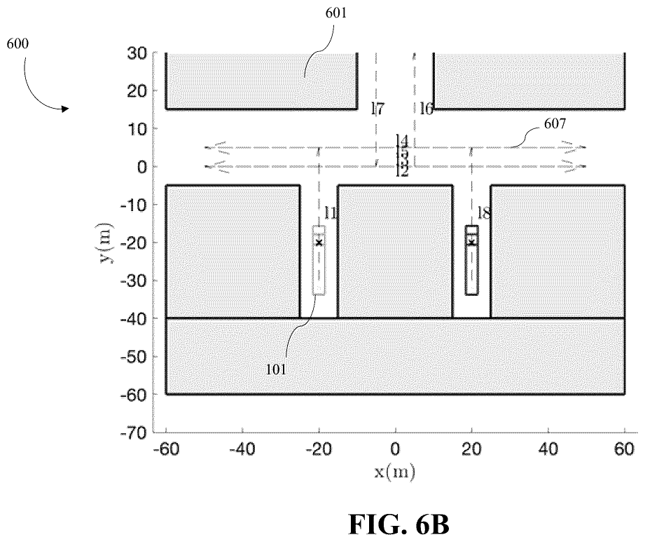

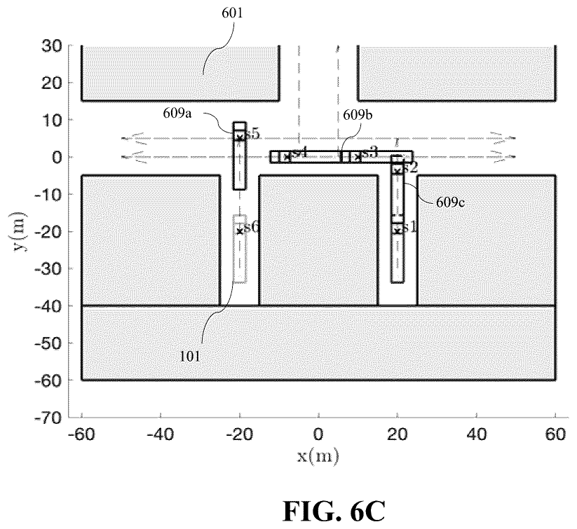

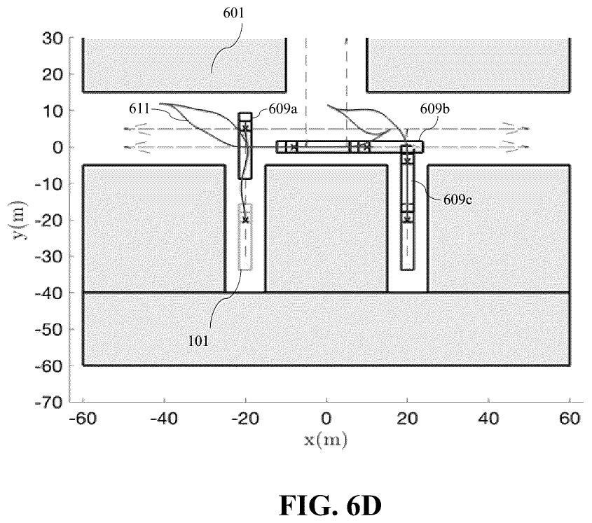

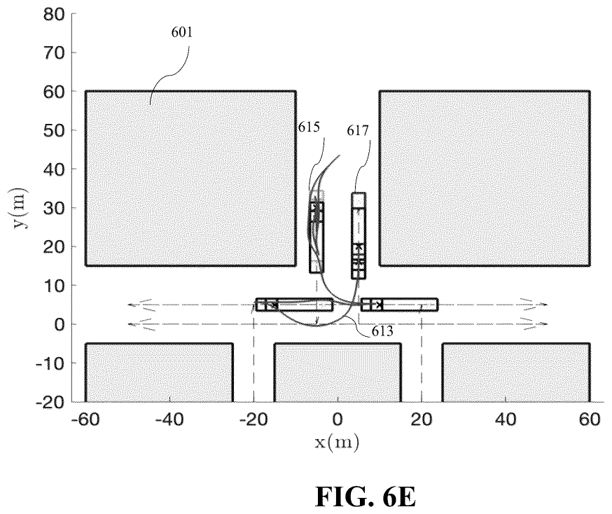

FIG. 6A illustrates a parking space 600, according to an embodiment of the present disclosure. The parking space 600 includes obstacles 601 that the trailer-based vehicle 101 should avoid. The system 600 is configured to control the motion of the trailer-based vehicle 101 from a current state/initial state 603 to a target parking spot 605 to park the trailer-based vehicle 101.

Given a map of the parking space 600, the system 115 constructs reference lines 607, shown in FIG. 6B. Further, the system 115 performs the graph-based search 113 on the reference lines, and the search results is (l₈, +)→(l₂, −)→(l₁, +), where +,− matches direction of x,y axes since the reference line segments are all parallel with the axes. The graph-based search 113 also outputs sub-goals 609a-609c shown in FIG. 6C, where every pair of successive sub-goals 609a-609c are connected with only one turn or straight line and the environment setup is similar to the corridor shown in FIG. 5. Further, the system 115 determines a trajectory 611, shown in FIG. 6D, connecting the sub-goals 609a-609c by solving optimization problem (10) using the policy trained through the primal-dual RL algorithm. The RL policy accomplishes the determination by not only taking system dynamics and constraints but also the corridor-alike environment setup into account. The system 115 controls the trailer-based vehicle 101 according the trajectory 611 to park the trailer-based vehicle 101 at the target parking spot 605.

Likewise, the system 115 also generates a trajectory 613, shown in FIG. 6E, for taking U-turn from its initial state 615 to a target state 617. The system 115 controls the trailer-based vehicle 101 according the trajectory 613 to take the U-turn and reach the target state 617.

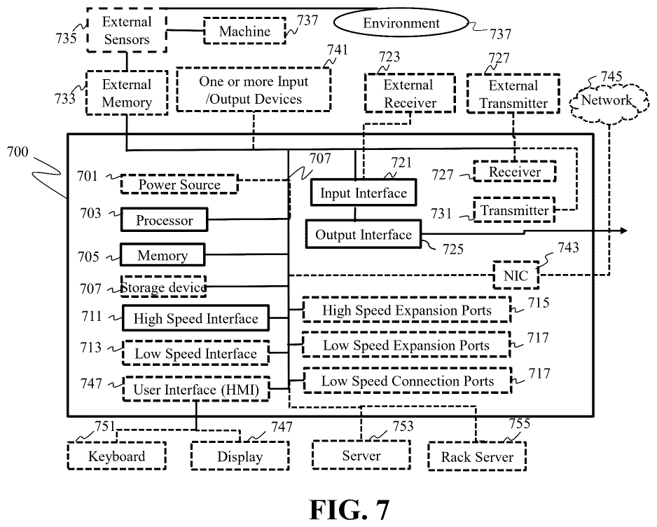

FIG. 7 is a schematic illustrating by non-limiting example a computing apparatus for implementing the methods and the systems of the present disclosure. The computing device 700 can include a power source 701, a processor 703, a memory 705, a storage device 707, all connected to a bus 709. Further, a high-speed interface 711, a low-speed interface 713, high-speed expansion ports 715 and low speed connection ports 717, can be connected to the bus 709. In addition, a low-speed expansion port 719 is in connection with the bus 709. Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700, historical data, and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. For example, the storage device 707 can store historical data and other related data as mentioned above regarding the present disclosure. Additionally, or alternatively, the storage device 707 can store historical data like data as mentioned above regarding the present disclosure. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 715, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A system for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer, the system comprising: a processor; and a memory having instructions stored thereon that, when executed by the processor, cause the system to:
perform a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair;
execute, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility;
generate a complete motion path for the trailer-based vehicle by concatenating the dynamically feasible motion trajectories associated with each pair of connected nodes in the sequence of connected nodes, wherein the complete motion path connects the initial state and the target state; and
control the motion of the trailer-based vehicle along the complete motion path to reach the target state in the environment.

2. The system of claim 1, wherein the directed graph of connected nodes is constructed using reference lines that represent the environment, and each node corresponds to a directed segment of a reference line with predefined orientations.

3. The system of claim 2, wherein, to generate the complete motion path for the trailer-based vehicle, the processor is configured to:
perform a high-level graph search on the directed graph of connected nodes to identify the sequence of connected nodes;
generate the dynamically feasible motion trajectory for each pair of connected nodes in the sequence of connected nodes, using a reinforcement learning-based trajectory optimization to ensure dynamically feasible transitions between states of the trailer-based vehicle; and
concatenate the dynamically feasible motion trajectories associated with each pair of connected nodes to form the complete motion path.

4. The system of claim 1, wherein the graph-based search uses a heuristic cost function based on Reeds-Shepp cost to estimate a shortest kinematically feasible path between nodes of the directed graph of connected nodes.

5. The system of claim 4, wherein the heuristic cost function based on Reeds-Shepp cost estimates the shortest kinematically feasible path between nodes by:
defining an edge cost between two nodes as a sum of a first Reeds-Shepp cost and a second Reeds-Shepp cost, wherein the first Reeds-Shepp cost represents a minimal turning distance for aligning the trailer-based vehicle with a reference line associated with the first node, and the second Reeds-Shepp cost represents a minimal turning distance from an aligned state to a reference line associated with the second node; and
prioritizing edge connections that minimize a total turning distance and maintain kinematic feasibility.

6. The system of claim 1, wherein the neural network trained either online or offline with the reinforcement learning incorporates reachability-based safety constraints to ensure collision-free trajectories between nodes of the directed graph of connected nodes.

7. The system of claim 6, wherein the reachability-based safety constraints are implemented by defining safety corridors along a trajectory connecting successive nodes, wherein the safety corridors are constructed based on relative positions and orientations of the trailer-based vehicle and nearby obstacles to ensure that the trailer-based vehicle remains within collision-free regions throughout its motion while incorporating constraints on a relative angle between the tractor and the trailer to prevent jackknife configurations during both forward and reverse motions of the trailer-based vehicle.

8. The system of claim 1, wherein the reinforcement learning uses a batch trajectory sampling technique to generate and evaluate multiple candidate trajectories for training.

9. The system of claim 1, wherein the reinforcement learning includes a stochastic policy that samples trajectories from a Gaussian distribution to generate multiple trajectory candidates between two nodes of the directed graph of connected nodes and select the best one to enhance trajectory precision and target state accuracy.

10. The system of claim 1, wherein the processor is further configured to initialize the neural network trained with reinforcement learning, using trajectories generated by solving open-loop optimal control problems.

11. The system claim 1 wherein the neural network implements a mapping between its input and output, wherein the input includes one or more of a current state of the trailer-based vehicle, the target state, maximum relative angle between the tractor and the at least one trailer and maximum steering angle of the trailer-based vehicle, vertices of obstacles present in the environment, and length and width of an open space in safety corridors, and wherein the output includes one or more control inputs of the trailer-based vehicle.

12. The system of claim 1, wherein the vehicle dynamics constraints include a jackknife prevention constraint that prevents a jackknife configuration of the trailer-based vehicle.

13. The system of claim 1, wherein the processor is further configured to dynamically adjust the graph-based search to account for changes in the environment, including updates to obstacle positions or traffic conditions.

14. The system of claim 1, wherein the initial node representing the initial state is a closest node on the directed graph to the initial state, and wherein the target node representing the target state is a closest node on the directed graph to the target state.

15. The system of claim 1, wherein the environment is a parking space, and the target state corresponds to a target parking spot in the parking space.

16. A method for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer, the method comprising:
performing a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair;
executing, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility;
generating a complete motion path for the trailer-based vehicle by concatenating the dynamically feasible motion trajectories associated with each pair of connected nodes in the sequence of connected nodes, wherein the complete motion path connects the initial state and the target state; and
controlling the motion of the trailer-based vehicle along the complete motion path to reach the target state in the environment.

17. The method of claim 16, wherein the directed graph of connected nodes is constructed using reference lines that represent the environment, and each node corresponds to a directed segment of a reference line with predefined orientations.

18. The method of claim 16, wherein the graph-based search uses a heuristic cost function based on Reeds-Shepp cost to estimate a shortest kinematically feasible path between nodes of the directed graph of connected nodes.

19. The method of claim 18, wherein the heuristic cost function based on Reeds-Shepp cost estimates the shortest kinematically feasible path between nodes by:
defining an edge cost between two nodes as a sum of a first Reeds-Shepp cost and a second Reeds-Shepp cost, wherein the first Reeds-Shepp cost represents a minimal turning distance for aligning the trailer-based vehicle with a reference line associated with the first node, and the second Reeds-Shepp cost represents a minimal turning distance from an aligned state to a reference line associated with the second node; and
prioritizing edge connections that minimize a total turning distance and maintain kinematic feasibility.

20. A non-transitory computer-readable storage medium embodied thereon a program executable by a processor for performing a method for controlling a motion of a trailer-based vehicle from an initial state to a target state in an environment, wherein each state includes at least a location and a heading of the trailer-based vehicle, the trailer-based vehicle comprising a tractor and at least one trailer attached to the tractor such that a motion of the tractor controls a motion of the at least one trailer, the method comprising:
performing a graph-based search on a directed graph of connected nodes to generate a sequence of connected nodes linking an initial node representing the initial state with a target node representing the target state, wherein each node on the directed graph defines a state of the trailer-based vehicle, and each edge connecting a pair of nodes defines a kinematically feasible motion of the trailer-based vehicle in a direction from a first node of the pair to a second node of the pair;
executing, for each pair of connected nodes in the sequence of connected nodes, a neural network trained with reinforcement learning to produce a dynamically feasible motion trajectory, wherein the dynamically feasible motion trajectory satisfies vehicle dynamics constraints, including collision avoidance and kinematic feasibility;
generating a complete motion path for the trailer-based vehicle by concatenating the dynamically feasible motion trajectories associated with each pair of connected nodes in the sequence of connected nodes, wherein the complete motion path connects the initial state and the target state; and
controlling the motion of the trailer-based vehicle along the complete motion path to reach the target state in the environment.
